(19) United States
(12) Patent Application Publication
(10) Pub. No.: US 2009/0313141 A1
(43) Pub. Date: Dec. 17, 2009

(54) METHOD, APPARATUS AND PROGRAM FOR PROVIDING PREVIEW IMAGES, AND SYSTEM FOR PROVIDING OBJECTS WITH IMAGES THEREON

(75) Inventor: Karin KON, Tokyo (JP)

Correspondence Address: YOUNG & THOMPSON, 209 Madison Street, Suite 500, Alexandria, VA, 22314, US

(73) Assignee: FUJIFILM Corporation, Tokyo (JP)

(21) Appl. No.: 12/482,918

(22) Filed: Jun. 11, 2009

(30) Foreign Application Priority Data
Jun. 11, 2008 (JP) 2008-153047

(51) Int. Cl. G06Q 30/00; G06N 7/02

(52) U.S. Cl. 705/27; 706/52

(57) ABSTRACT

A preview image providing method for providing a preview image of an object having an image thereon includes the steps of: estimating the user's needs from information unique to the user; determining an image and an object based on the results of estimation; and providing a preview image of the determined object, which is synthesized with the determined image.

### BACKGROUND OF THE INVENTION

1. Field of the Invention

The present invention is related to a method and an apparatus for providing a preview image of an object having an image thereon The present invention is also related to a program that causes a computer to execute the preview image providing method. In addition, the present invention is related to a system for providing objects with images thereon.

2. Description of the Related Art

Recently, communications networks such as the Internet are in wide use. Japanese Unexamined Patent Publication No. 2002-140612 discloses a method that provides information regarding products (real estate) suited to customers via a network, based on the customers' attribute data.

In addition, images photographed by digital cameras are treated as digital image data. The digital image data are transmittable utilizing communications networks, and various services have been proposed that takes advantage of this fact.

Japanese Unexamined Patent Publication No. 2007-060562 discloses a method in which recommended images suited for synthesizing services (such as prints) are selected from among a plurality of input images, based on the image qualities and the states of subjects pictured therein, and proposed to users.

In addition, a service has been proposed, in which objects such as coffee mugs, calendars, and articles of clothing having photographic images thereon are provided, wherein orders are received via a communications network. In this service, a user selects a desired object and a photographic image to be provided thereon. Data regarding the selected object, the selected photographic image, and an image that illustrates a state in which the photographic image is provided on the object, are transmitted from a user terminal as order information to a server of a service center that provides the service via a communications network. Thereby, the service center receives the order information, produces the product according to the order, and delivers the product to the user.

However, in the above method, the user must select the desired object and the photographic image to be provided thereon, and also must synthesize are, image of the object with the photographic image to preview the finished product, which is troublesome

### SUMMARY OF THE INVENTION

The present invention has been developed in view of the foregoing circumstances. It is an object of the present invention to provide a method, apparatus, and program for providing preview images which are capable of automatically providing preview images of objects having images thereon that users desire.

A preview image providing method of the present invention is a method for providing a preview image of an object having an image thereon, and comprises the steps of:

estimating the user's needs from information unique to the user;

determining an image and an object based on the results of estimation; and

providing a preview image of the determined object, which is synthesized with the determined image.

A preview image providing apparatus of the present invention provides a preview image of an object having an image thereon, and comprises:

needs estimating means, for estimating the user's needs from information unique to the user;

determining means, for determining an image and an object based on the results of estimation; and

preview image providing means, for providing a preview image of the determined object, which is synthesized with the determined image.

In the aforementioned apparatus, the information unique to the user may be at least one of: images held by the user, the user's image viewing history, the user's personal information, and the user's history of activity.

The preview image providing means may provide the preview image at a timing based on anniversary date information of the user.

The object may be at least one of: a coffee mug, a calendar, an article of clothing, a stuffed animal, a mouse pad, and a jigsaw puzzle.

The preview image providing means may be equipped with correcting means, for correcting at least one of the object and the image which has been provided by the preview image providing means.

The determining means may be equipped with correcting means, for correcting at least one of the object and the image which has been determined by the determining means.

A system for providing objects with images thereon of the present invention comprises:

a preview image providing apparatus of the present invention;

order information outputting means, for outputting order information for ordering the object having the image synthesized therewith, represented by the preview image which is provided by the preview image providing means of the preview image providing apparatus; and

order receiving means, for receiving the order information which is output by the order information output means.

A preview image providing program of the present invention is a program that causes a computer to execute a preview image providing method, for providing a preview image of an object having an image thereon, the program comprising the procedures of:

estimating the user's needs from information unique to the user;

determining an image and an object based on the results of estimation; and

providing a preview image of the determined object, which is synthesized with the determined image.

Here, the phrase “determining an image and an object based on the results of estimation” means that at least one of a process for determining the image and a process for determining the object is performed based on the results of estimation of the user's needs.

The term “user's personal information” refers to information regarding the individual user, such as the user's sex, birth date, nationality, job, family structure, anniversary dates, information regarding the user's friends, and facial photographs, for example.

The term “user's history of activity” refers to keyword logs of searches input by the user into a personal computer, logs of sent and received e-mails, logs of previously ordered objects or objects having images thereon, and history of actual movement during the user's everyday life.

Note that the program of the present invention may be provided being recorded on a computer readable medium. Those who are skilled in the art would know that computer readable media are not limited to any specific device and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of the present invention. Additionally, computer instructions include, but are not limited to: source, object, and executable code, and can be in any language, including higher level languages, assembly language, and machine language.

In the preview image providing method, the preview image providing apparatus, and the preview image providing program of the present invention, user's needs are estimated from information unique to the user. Then, an image and an object are determined based on the results of estimation, and a preview image of the determined object, which is synthesized with the determined image, is provided. Thereby, preview images of objects having images thereon that users desire are automatically provided. Accordingly, the burden placed on users by the troublesome operations of selecting images and objects, and synthesizing an image of the object with the photographic image to preview the finished product, can be reduced.

### BRIEF DESCRIPTION OF THE DRAWINGS

FIG. 1 is a block diagram that illustrates the schematic structure of a system that provides objects having images thereon.

FIG. 2 is a block diagram that illustrates the construction of a preview image providing apparatus.

FIG. 3 is a diagram that illustrates examples of information unique to users, obtained by a user needs estimating section.

FIG. 4 is a diagram that illustrates keyword rankings, generated by the user needs estimating section.

FIG. 5 is a diagram that illustrates ordered object rankings, generated by the user needs estimating section.

FIG. 6 is a diagram that illustrates sales rankings for objects having images thereon, which is referred to by an image/object determining section.

FIG. 7 is a flow chart that illustrates an example of a process which is performed by the preview image providing apparatus.

FIG. 8 is a flow chart that illustrates an example of a process which is performed at step ST2 of the flow chart of FIG. 7.

FIG. 9 is a flow chart that illustrates an example of a process which is performed at step ST3 of the flow chart of FIG. 7.

FIG. 10 is a diagram for explaining a preview image generating process which is performed by a preview image providing section.

FIG. 11 is a diagram for explaining an alternate preview image generating process which is performed by the preview image providing section.

### BEST MODE FOR CARRYING OUT THE INVENTION

An embodiment of the present invention will be described with reference to the attached drawings.

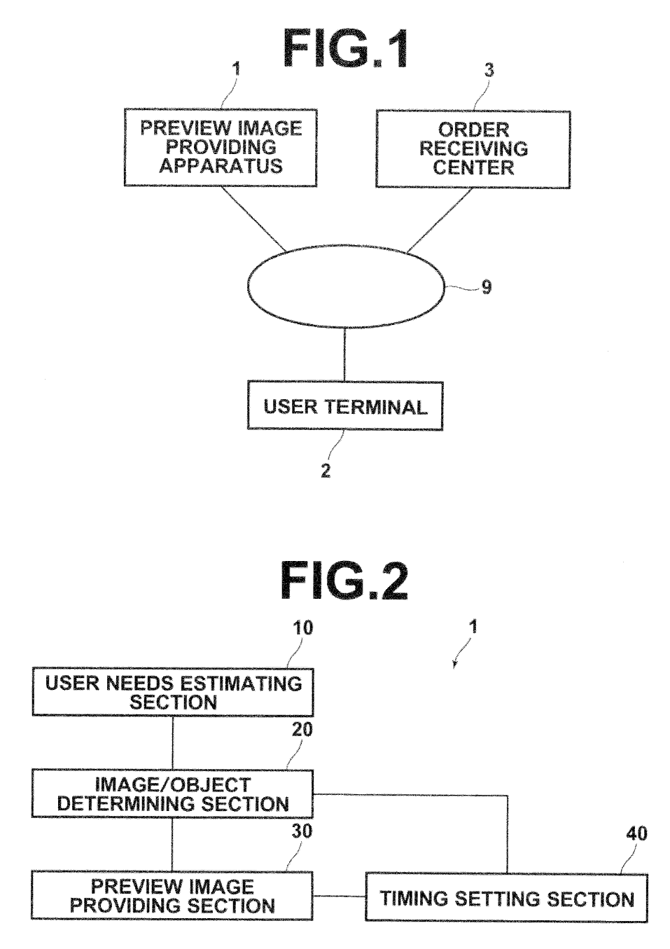

FIG. 1 is a block diagram that illustrates the schematic structure of a system that provides objects having images thereon. As illustrated in FIG. 1, the system is constituted by: a preview image providing apparatus 1; a user terminal 2 (order information outputting means); and an order receiving center 3 (order receiving means), which are connected via a network 9 in a communicable state.

The preview image providing apparatus 1 provides users with preview images of objects having images thereon, in which images and objects which have been determined based on estimation results of the users' needs are pictured. As illustrated in FIG. 2, the preview image providing apparatus 1 is equipped with: a user needs estimating section 10; an image/object determining section 20; a preview image providing section 30; a timing setting section 40, and the like.

The user terminal 2 may be a personal computer (PC), a PDA, a cellular telephone, or the like. The user terminal 2 displays preview images of objects having images thereon provided by the preview image providing apparatus 1 on a display screen thereof. In addition, the user terminal 2 transmits order information for objects having images thereon that a user desires to the order receiving center 3, according to user input.

The order receiving center 3 receives order information output by the user terminal 2. Products are manufactured according to the received order information, then delivered to users.

The user needs estimating section 10 estimates the needs of users, based on information unique to the users. Particularly, the user needs estimating section 10 estimates needs related to objects having images thereon.

The user needs estimating section 10 sets unique user ID's to discriminate each user. The user needs estimating section 10 collects information unique to the users from various information sources, such as users' PC's, databases connected to networks, and applications utilized by the users. The collected information is recorded correlated with the user ID's, and the users' needs are estimated based on the recorded information.

Here, the information unique to the users refers to information that enables prediction of needs related to objects having images thereon, from among various types of information related to the users. Examples of such information include: images stored in the hard drives of users' PC's; images stored in memory devices such as file servers connected to the users' PC's via networks; images viewed by the users via networks, the users' sex; the users' birth date; the users' nationality; the users' profession; the users' family structure; the users' anniversaries; information regarding the users' friends; facial photographs of the users'; keyword logs of searches input by the users into personal computers, logs of sent and received e-mails, logs of previously ordered objects or objects having images thereon, and history of actual movement during the users' everyday lives.

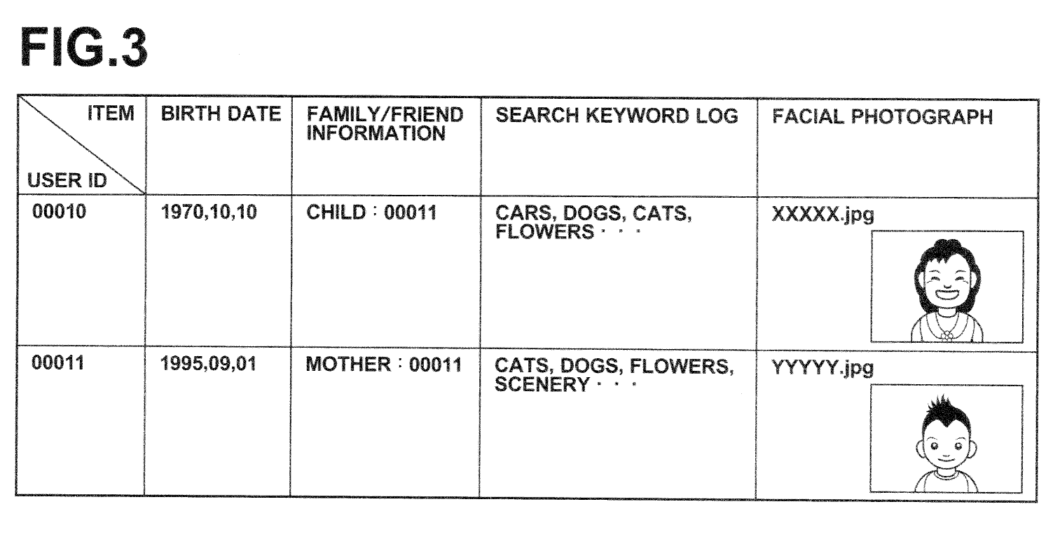

FIG. 3 is a diagram that illustrates examples of information unique to users, obtained by the user needs estimating section 10. The birthdates, family/friends information, history of search keywords, and facial photographs of user 00010 and user 00011, who are parent and child, are recorded correlated with their user ID's.

Hereinafter, a process by which users' needs are estimated based on the information unique to the users will be described with reference to specific examples.

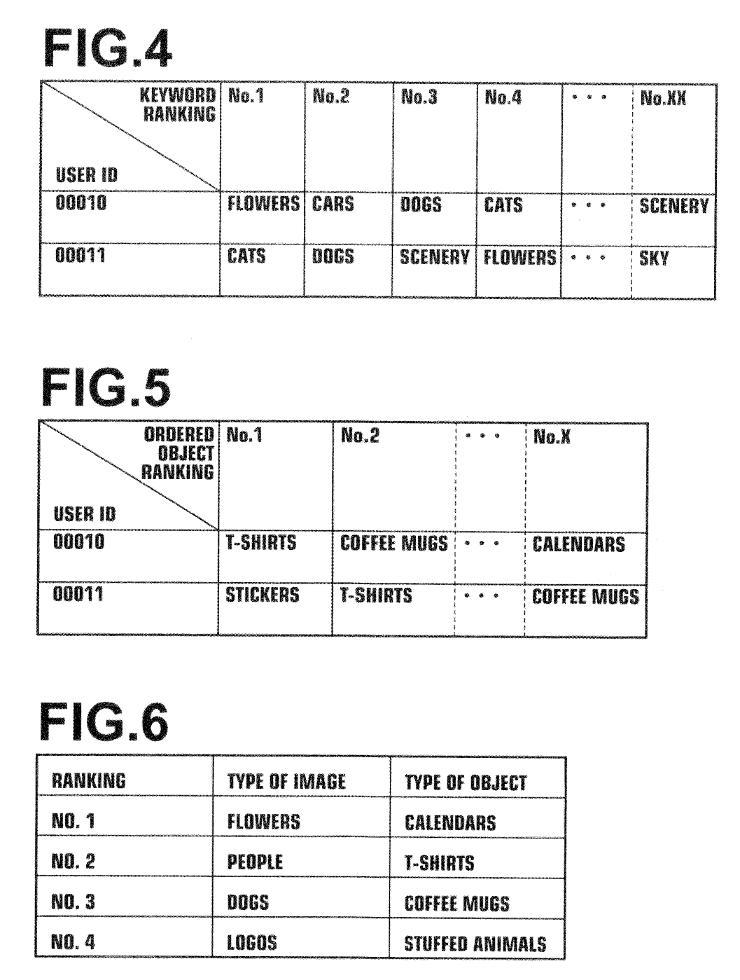

For example, keywords that represent the contents of each image in a user's viewing history may be extracted, by obtaining tag information of the images. In cases that there is no tag information, keywords that represent the contents of the images can be extracted by administering scene analysis processes or object recognition processes thereon. Then, the extracted keywords may be counted. Alternatively, keywords from keyword logs of searches input by the user may be counted, or the keywords extracted from the images and the keywords from the keyword logs of searches may be combined and counted. Rankings of keywords such as that illustrated in FIG. 4 are produced based on the counts. It is estimated that objects having images thereon related to keywords having high rankings are desired by the user.

It is also possible to count the purchase history of a user, and to count the number of times that each type of object have been ordered. Rankings of ordered objects such as that illustrated in FIG. 5 may be produced. It may be estimated that objects having high rankings are those desired by the user.

In addition, in the case that a user has a great number of images of dogs, a pet shop is along tile movement path of the user, which is obtained by GPS positional tracking, or the like, this information may be used to assume that the user has an interest in pets. In this case, it may be estimated that objects having images thereon related to pets are desired by the user.

Further, it may be estimated that objects having images thereon related to various anniversary dates of a user, such as the user's birthday and the user's wedding anniversary, are those desired by the user. It may also be estimated that objects having images thereon related to various anniversary dates of the user's friends and family are those desired by the user to be given as gifts, based on the information regarding the user's family structure and information regarding the user's friends.

Still further, if there are objects having images thereon which are statistically frequently desired by people of a similar age, similar sex, similar nationality, or similar profession as a user, it may be estimated that such objects having images thereon are desired by the user, when the age, sex, nationality, or profession of the user is referred to.

The image/object determining section 30 determines images and objects that constitute objects having images thereon so as to obtain objects having images thereon which have been estimated to match the needs of users, estimated by the user needs estimating section 10.

The image/object determining section 20 has information related to the types of objects which can be provided to users when orders are received therefor. Objects that constitute the objects having images thereon are determined from within a group of objects which can be provided. Examples of the contents of such a group include: coffee mugs, calendars, tapestries, articles of clothing, stuffed animals, mouse pads, jigsaw puzzles, cards (post cards, greeting cards, etc.), images, and photo albums.

The image/object determining section 20 determines images that constitute objects having images thereon by searching for images in predetermined search ranges within image databases that include images owned by users and images which are published on networks. Keywords that represent the contents of each image extracted, by obtaining tag information of the images. In cases that there is no tag information, keywords that represent the contents of the images can be extracted by administering scene analysis processes or object recognition processes thereon. The types of images are specified based on the extracted keywords. The degrees of matching with users' needs are evaluated based on the types of images. Further, whether images are suited for use as images that constitute the objects having images thereon is evaluated from the sizes of the images, the resolutions of the images, the compositions of the images, the aspect ratios of the images, the states of main pictured subjects, the quality of the images, and the like. Final determinations are performed based on the evaluation values.

Here, the term “search range” refers broadly to ranges that limit the process for searching for images. The search range may be set according to various conditions. For example, only specific folders within image databases may be set as the search range. Alternatively, the search range may be set such that searching is limited to a predetermined amount of time or less. As a further alternative, each image within a folder which is being searched in may be sequentially evaluated by measures such as degree of matching with users' needs, the state of a main pictured subject, and image quality. The search range may be set such that the search may be ceased when an image having evaluation values greater than predetermined threshold values is found. As a still further alternative, only images having times/dates of photography during specific periods may be set as targets of searching. As still another alternative, only images which have been viewed by the public a number of times that exceeds a predetermined threshold value may be set as targets of searching. As still yet another alternative, only images having ratings, assigned by visitors within an online community or the like, greater than a predetermined threshold value may be set as targets of searching.

Note that the search range may be set to a default setting in advance. Alternatively, the search range may be set by user input of various conditions. As a further alternative, the search range may be set automatically, based on information unique to users, which is collected by the user needs estimating section 10. The search range may be fixed during searching, or may be changed during searching according to the states of searches.

Specifically, the determination of an image and an object for a specific user by the image/object determining section 30 is performed by: determining an image having the highest degree of matching with the estimated needs of the user from among a group of selectable images, and then determining an object that can be favorably combined with the determined image; determining an object having the highest degree of matching with the estimated needs of the user from among a group of selectable objects, and then determining an image that can be favorably combined with the determined object; determining both an image and an object having the highest degrees of matching with the estimated needs of the user from among groups of selectable images and objects; or determining a combination of an object and an image having the highest degree of matching from among a group of combinations of selectable objects and images.

For example, in the case that the user needs estimating section 10 estimates that a user desires an object having an image thereon related to dogs because the user owns a great number of images of dogs, an image of a dog is determined as an image having the highest degree of matching with the user's needs, from among a group of selectable images. Next, sales rankings for objects having images thereon, as illustrated in FIG. 6, are referred to. Then, the object which has been ordered most often in combination with the determined image (coffee mugs in the example of FIG. 6) is selected as an object which can be favorably combined with the determined image.

As another example, coffee mugs may be the highest ranked among objects previously purchased by a user, and it may be estimated that the user desires a coffee mug. In this case, a coffee mug is determined as an object having the highest degree of matching with the user's needs, from among a group of selectable objects. Next, sales rankings for objects having images thereon, as illustrated in FIG. 6, are referred to. Then, the image which has been ordered most often in combination with the determined object (images of dogs in the example of FIG. 6) is selected as an image which can be favorably combined with the determined object.

As still another example, a case will be considered in which it is a user's birthday, and it is estimated that the user desires an object having an image thereon related to the user's birthday In this case, for example, a collection of photographic images having the user as a main subject during the birthday month of the user over the past several years may be obtained. The collection of photographic images may be synthesized into a single image, and determined as an image having a high degree of matching with the user's needs. Then, an object, which can be favorably combined with the synthesized image that has a comparatively large area for an image to be provided on, such as a calendar or an article of clothing, may be determined to be an object that can be favorably combined with the determined image. Here, the photographic images having the user as the main subject may be collected from among a group of images owned by the user by employing face recognition based on a facial photograph of the user, which has been obtained by the user needs estimating section 10 as information unique to the user.

As still yet another example, a case will be considered in which a user has a baby, and it is estimated that the user desires an object related to babies. In this case, an image and an object suitable for babies may be determined. For example, objects such as a stuffed animal, a coffee mug, and a calendar are determined as an object having higher degrees of matching with the user's needs than objects such as a jigsaw puzzle, a mouse pad, a sweatshirt.

Note that in the case that a “stuffed animal” is determined as an object that matches the user's needs, an image that matches the cute and cheerful impression of the stuffed animal may be determined to be an image to be combined with the object. For example, an image of a child's face, an image having bright colors an image of a flower, and logos in rounded fonts are determined to be images which are suited to the object, “stuffed animal”, over images of all adult's face, a black and white image, an image of a building, and logos in block lettered fonts.

A case will be considered in which an “image” is determined to be an object that matches a user's needs. In this case, an image that matches the estimated needs of the user is determined to be the object, from among a group of selectable images. For example, a group of images having degrees of matching with the user's needs greater than a predetermined threshold may be determined, from within an image database that includes images owned by the user and images which are published on networks. The oldest image, the newest image, an image having the most color information, an image having the least color information, an image having the greatest amount of contrast, or an image having the least amount of contrast from among the plurality of images that constitute the group of images may be determined as the object. Alternatively, image analysis, such as subject detection and frequency analysis, may be administered onto each image that constitutes the group of images, and an image having a large subject, an image having a small subject, an image from which a subject is not detected (an image of scenery), or an image having a large percentage of low frequency components (an image in which a large amount of space is pictured) may be determined as the object.

Note that objects having decorations limited to specific seasons and images which have been photographed during time periods close to the timing that a preview image is to be provided may be prioritized and determined, according to the timing at which the preview image is to be provided. For example, in the case that a preview image is to be provided in December, a stuffed animal wearing a Santa Claus outfit may be prioritized over regular stuffed animals, a coffee mug having a Christmas tree design may be prioritized over regular coffee mugs, and images having photography dates in December may be prioritized during the determination process.

Note that the methods for determining the image and the object described above may be utilized in combination as desired, according to the needs of users estimated by the user needs estimating section 10. In addition, the methods described above are merely examples, and other methods may be employed to determine the image and the object.

There may be cases in which the user needs estimating section 10 estimates a plurality of different needs for a user, based on the information unique to the user in these cases, it is preferable for the degree of desire for each estimated need to be evaluated, for a ranking of the needs to be determined, and for determination of the image and the object by the image/object determining section 30 to be performed based on the ranking.

The image/object determining section 20 may take the appearance of the combination of a determined image and a determined object into consideration after determining an image and an object to be combined. Various corrections may be administered, such as: changing one or both of the determined object and the image; changing the color of at least a portion of the object on which the image is to be provided; changing the color of the entire object; changing the size of the image; and changing the position of the object at which the image is to be provided. The corrected image and object may be determined as an image and an object that constitutes the object having an image thereon.

The preview image providing section 30 generates a preview image of an object having an image thereon, by synthesizing an image of a determined image and an image of a determined object, based on data regarding the image and the object which have been determined by the image/object determining section 20. The generated preview image is provided to the user, at a timing set by the timing setting section 40 to be described later.

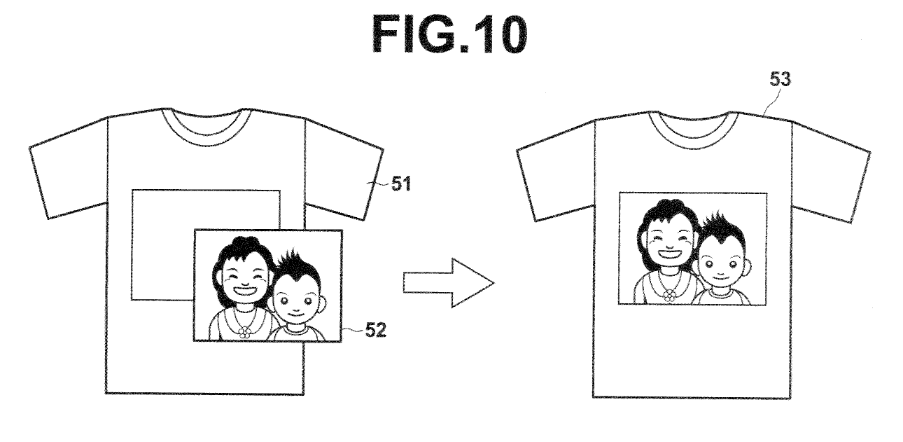

Specifically, as illustrated in FIG. 10, an image of a T shirt 51 as a determined object and a determined image 52 are synthesized such that the image 52 is provided on the front surface of the T shirt 51. Thereby, a preview image of a T shirt 53 having an image thereon (object having an image thereon) is generated.

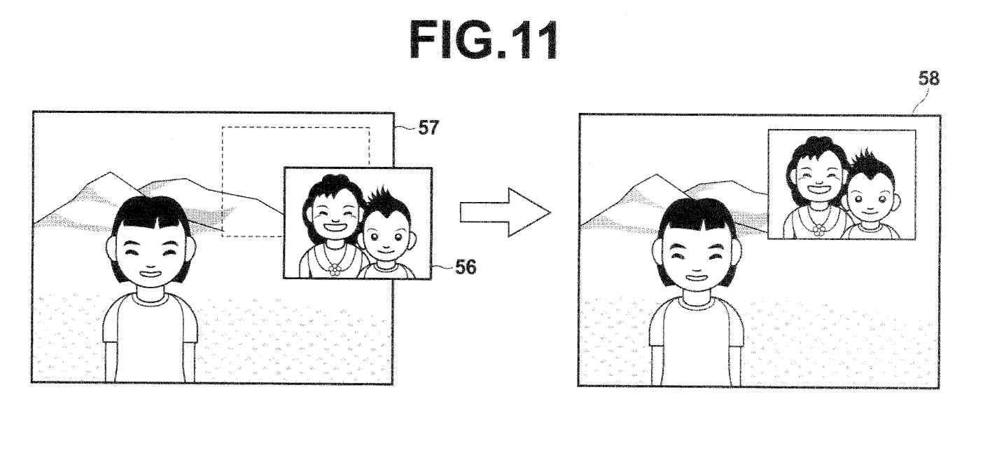

Note that in the case that the object is an image, as illustrated in FIG. 11, a determined image 56 and an image 57 which has been determined as the object are synthesized to generate a preview image of an image 58 having an image thereon (object having an image thereon). Here, when the preview image of the image having an image thereon is generated, the images may be synthesized such that one of the images overlaps a portion of the other image. Alternatively, the images may be synthesized such that they are linked, without any overlapping portions. In the case that the images are synthesized such that one of the images overlaps a portion of the other image, it is preferable for the images to be synthesized such that the overlapping image does not cover a portion of the other image at which a main subject is pictured. This may be accomplished by detecting a main subject region, for example, the facial region of a human subject, within the images by a conventional subject detecting technique.

The preview image providing section 30 distributes the preview images themselves or links to the preview images to users via e-mail, or uploads the preview images or links onto websites which are viewed by the users, to provide the preview images. Alternatively, the preview images may be provided by being displayed as pop up images on display screens of users' PC's, users' television sets, users' cellular telephones, or the like.

Note that the preview image providing section 30 is also capable of providing a plurality of different preview images to a single user. For example, a default number of preview images or a number of preview images set by a user may be provided. If further preview images are desired, additional preview images maybe provided Here, when the plurality of preview images are provided, the image/object determining section 30 determines a plurality of combinations of images and objects that constitute objects having images thereon that match the user's needs. The preview image providing section 30 then provides preview images of the objects having images thereon, constituted by each combination of an image and an object, to the user.

The timing setting section 40 sets the timings at which the preview image providing section 30 provides preview images. Examples of the timings which are set by the timing setting section 40 include: regular time intervals, such as the same day every month; timings based on anniversaries, such as birthdays and wedding anniversaries, of users, their friends, and their families; whenever a request for a preview image is received from a user; and whenever new objects or new images that can be provided to users are registered.

Here, in the case that a preview image is provided at a timing that a new object is registered, the image/object determining section 20 determines an image that matches the needs of a user and can be favorably combined with the new object. Then, the preview image providing section 30 provides a preview image of an object having an image thereon constituted by the new object and the determined image.

In the case that a preview image is provided at a timing that a photographic image of a celebrity, such as an athlete or a movie star, is registered as a new image, the image/object determining section 20 determines an object that matches the needs of a user and can be favorably combined with the new image. Then, the preview image providing section 30 provides a preview image of an object having an image thereon constituted by the new image and the determined object.

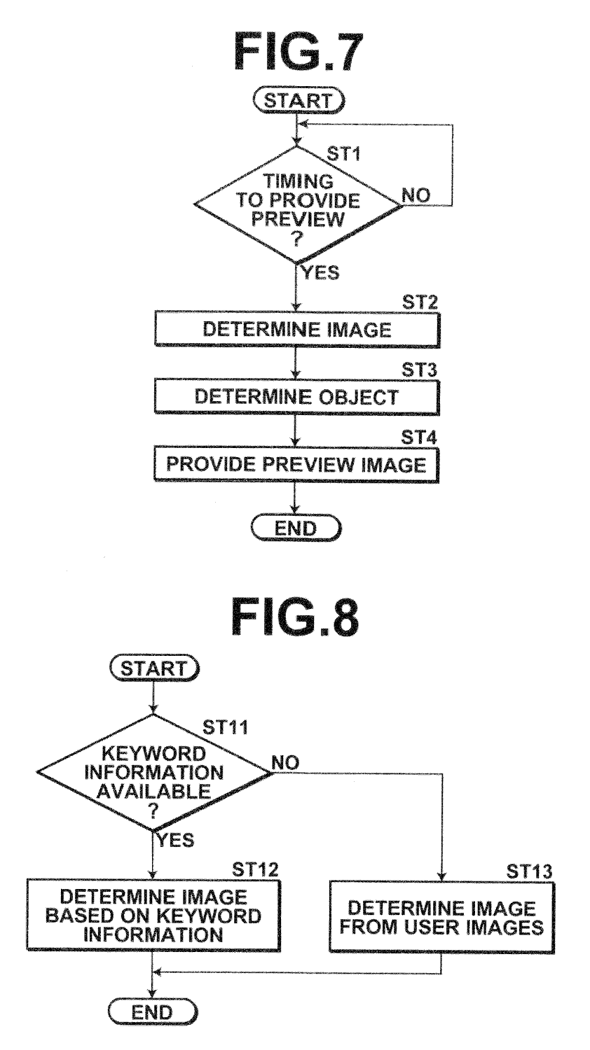

Examples of processes performed by the preview image providing apparatus 1 will be described with reference to the flow charts of FIG. 7 through FIG. 9.

First, as illustrated in FIG. 7, judgment is performed regarding whether it is a timing to provide a preview image, based on a timing setting which is set in the timing setting section 40 (step ST1). In the case that the result of judgment at step ST1 is affirmative, the image/object determining section 20 determines an image that is to constitute an object having an image thereon represented by a preview image (step ST2). Further, an object that is to constitute the object having the image thereon is determined (step ST3). Next, the preview image providing section 30 provides the preview image of the object having the image thereon, constituted by the image and the object which were determined in step ST2 and step ST3 (step ST4).

An example of a process for determining the image at step ST2 is illustrated by the flow chart of FIG. 8. First, the user needs estimating section 10 judges whether a search keyword log of a user has been obtained as information unique to the user (step ST11). In the case that the result of judgment at step ST11 is affirmative, the user needs estimating section 10 counts the keywords of the keyword log, and generates keyword rankings. It is estimated that an image related to the highest ranked keyword is desired, and the image/object determining section 20 determines an image that matches the estimated user need as the image to be included in the preview image (step ST12). On the other hand, in the case that the result of judgment at step ST11 is negative, the image/object determining section 30 determines an image suited for the object having an image thereon from among images owned by the user, as the image to be included in the preview image (step ST13).

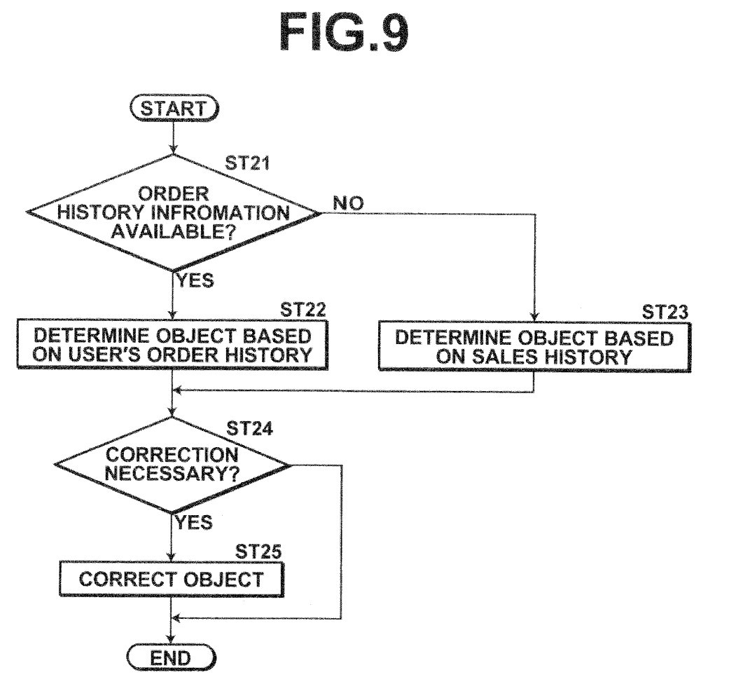

An example of a process for determining the object at step ST3 is illustrated by the flow chart of FIG. 9. First, the user needs estimating section 10 judges whether a user's order history of objects has been obtained as information unique to the user (step ST21). In the case that the result of judgment at step ST21 is affirmative, the user needs estimating section 10 counts the number of times that each type of object has been purchased from the order history, and generates purchased item rankings. It is estimated that an object having the highest purchase ranking is desired, and the image/object determining section 20 determines the object as the object to be included in the preview image (step ST22). On the other hand, in the case that the result of judgment at step ST21 is negative, the image/object determining section 30 determines an object which has the highest sales, based on sales records of objects having images thereon, as the object to be combined with the determined image (step ST23). Next, the image/object determining section 20 takes the appearance of the combination of the image determined in step ST2 and the object determined in step ST22, or step ST23 into consideration, and judges whether it is necessary to change the color of at least a portion of the object on which the image is to be provided or to change the color of the entire object (step ST24). In the case that the result of judgment at step ST24 is affirmative, the color of at least a portion of the object is corrected according to the color of the image, the corrected object is determined as the object to be included in the preview image of the object having the image thereon (step ST25), and the process ends. On the other hand, in the case that the result of judgment at step ST24 is negative, the process ends.

Note that the correcting process which is administered onto the object at step ST25 may be to change the color of the portion of the object where the image is to be provided to white, and to change the color of the other portions of the object to red, in the case that the color of the image is pink, for example. Another example of the correcting process is to change the color of the portion of the object where the image is to be provided to yellow, and to change the color of the other portions of the object to light blue, in the case that the color of the image is blue.

Users may perform predetermined operations, such as clicking on the preview image which is provided by the preview image providing section 30 and displayed on the display screen of the user terminal 2 via an input means of the user terminal, to order the object having an image thereon represented by the preview image. In addition, an ordering application may be utilized to perform various correcting processes, such as: changing one or both of the object and the image pictured in the preview image provided by the preview image providing apparatus 1; changing the color of the object; changing the size of the image; changing the position at which the image is provided on the object, and an order maybe placed with the corrected contents. Note that this ordering application corresponds to the correcting means for correcting at least one of the object and the image within the preview image which has been provided by the preview image providing means of the present invention.

According to the embodiment described above, the user needs estimating section 10 estimates a user's needs from information unique to the user. The image/object determining section 20 determines an image and an object based on the results of estimation. Then, the preview image providing section 30 provides a preview image of the determined object, which is synthesized with the determined image. Thereby, preview images of objects having images thereon that users desire are automatically provided. Accordingly, the burden placed on users by the troublesome operations of selecting images and objects, and synthesizing an image of the object with the photographic image to preview the finished product, can be reduced.

Note that the above embodiment has been described as a case in which the image/object determining section 30 determines both the image and the object that constitute the object having the image thereon. However, in the case that information regarding an image or an object that a user desires has been obtained, only an object (or an image) that can be favorably combined with the desired image (or object) can be determined. Then, the preview image providing section 30 can provide a preview image of an object having an image thereon constituted by the image (or object) desired by the user and the determined object (or image).

What is claimed is:

1. A preview image providing method, for providing a preview image of an object having an image thereon, comprising the steps of:
estimating the user's needs from information unicycle to the user;
determining an image and an object based on the results of estimation; and
providing a preview image of the determined object, which is synthesized with the determined image.

2. A preview image providing apparatus, for providing a preview image of an object having an image thereon, comprising:
needs estimating means, for estimating the user's needs from information unique to the user;
determining means, for determining an image and an object based on the results of estimation; and
preview image providing means, for providing a preview image of the determined object, which is synthesized with the determined image.

3. A preview image providing apparatus as defined in claim 2, wherein:
the information unique to the user is at least one of: images held by the user, the user's image viewing history, the user's personal information, and the user's history of activity.

4. A preview image providing apparatus as defined in claim 2, wherein:
the preview image providing means provides the preview image at a timing based on anniversary date information of the user.

5. A preview image providing apparatus as defined in claim 3, wherein:
the preview image providing means provides the preview image at a timing based on anniversary date information of the user.

6. A preview image providing apparatus as defined in claim 2, wherein:
the object is at least one of: a coffee mug, a calendar, an article of clothing, a stuffed animal, a mouse pad, and a jigsaw puzzle.

7. A preview image providing apparatus as defined in claim 3, wherein:
the object is at least one of: a coffee mug, a calendar, an article of clothing, a stuffed animal, a mouse pad, and a Jigsaw puzzle.

8. A preview image providing apparatus as defined in claim 4, wherein:
the object is at least one of: a coffee mug, a calendar, an article of clothing, a stuffed animal, a mouse pad, and a jigsaw puzzle.

9. A preview image providing apparatus as defined in claim 2, wherein:
the object is at least one of: an image, a photograph album, and a greeting card.

10. A preview image providing apparatus as defined in claim 3, wherein:
the object is at least one of: an image, a photograph album, and a greeting card.

11. A preview image providing apparatus as defined in claim 2, wherein:
the preview image providing means is equipped with correcting means, for correcting at least one of the object and the image within the preview image which has been provided by the preview image providing means.

12. A preview image providing apparatus as defined in claim 3, wherein:
the preview image providing means is equipped with correcting means, for correcting at least one of the object and the image within the preview image which has been provided by the preview image providing means.

13. A preview image providing apparatus as defined in claim 4, wherein:
the preview image providing means is equipped with correcting means, for correcting at least one of the object and the image within the preview image which has been provided by the preview image providing means.

14. A preview image providing apparatus as defined in claim 2, wherein:
the determining means is equipped with correcting means, for correcting at least one of the object and the image which has been determined by the determining means.

15. A preview image providing apparatus as defined in claim 3, wherein:
the determining means is equipped with correcting means, for correcting at least one of the object and the image which has been determined by the determining means.

16 A preview image providing apparatus as defined in claim 4, wherein:
the determining means is equipped with correcting means, for correcting at least one of the object and the image which has been determined by the determining means.

17. A system for providing objects with images thereon, comprising:
a preview image providing apparatus as defined in claim 2;
order information outputting means, for outputting order information for ordering the object having the image synthesized therewith, represented by the preview image which is provided by the preview image providing means of the preview image providing apparatus; and
order receiving means, for receiving the order information which is output by the order information output means.

18. A system for providing objects with images thereon, comprising:
a preview image providing apparatus as defined in claim 3;
order information outputting means, for outputting order information for ordering the object having the image synthesized therewith, represented by the preview image which is provided by the preview image providing means of the preview image providing apparatus; and
order receiving means, for receiving the order information which is output by the order information output means.

19. A system for providing objects with images thereon, comprising:
a preview image providing apparatus as defined in claim 4;
order information outputting means, for outputting order information for ordering the object having the image synthesized therewith, represented by the preview image which is provided by the preview image providing means of the preview image providing apparatus; and
order receiving means, for receiving the order information which is output by the order information output means.

20. A computer readable medium having recorded therein a program that causes a computer to execute a preview image providing method, for providing a preview image of an object having an image thereon, the program comprising the procedures of:
estimating the user's needs from information unique to the user;
determining an image and an object based on the results of estimation; and
providing a preview image of the determined object, which is synthesized with the determined image.
